(19) United States
(12) Patent Application Publication
(10) Pub. No.: US 2012/0236592 A1
(43) Pub. Date: Sep. 20, 2012

(54) DISPLAY APPARATUS INCLUDING LIGHT GUIDE PLATE COUPLING MEMBER

(76) Inventors: Eui Jeong KANG, Asan-si (KR); Juhwa Ha, Asan-si (KR); Kwang Jin Jeong, Cheonan-si (KR); Seki Park, Asan-si (KR); Dongmin Yeo, Asan-si (KR); Chan-Jae Park, Suyeong-gu (KR)

(21) Appl. No.: 13/354,260

(22) Filed: Jan. 19, 2012

(30) Foreign Application Priority Data
Mar. 17, 2011 (KR) 10-2011-0024023

(51) Int. Cl. F21V 7/04; F21V 8/00

(52) U.S. Cl. 362/609; 362/633; 362/613; 362/616

(57) ABSTRACT

Provided is a display apparatus, which includes a light source unit providing light, a light guide panel guiding the light to a display panel, the display panel receiving the light to display an image, and a bottom chassis accommodating the light guide panel, the light source unit, and the display panel. The light guide panel is adjacent to the light source unit, and includes a light incident surface to which the light is incident, a light output surface from which the light is emitted, and an opposite surface opposed to the light output surface. The display panel faces the light output surface and receives the light to display an image. The bottom chassis has a bottom facing the opposite surface. The light guide panel includes a coupling member protruding from the opposite surface and coupled to the bottom chassis.

### CROSS-REFERENCE TO RELATED APPLICATIONS

This U.S. non-provisional patent application claims priority under 35 U.S.C. §119 to Korean Patent Application No. 10-2011-0024023, filed on Mar. 17, 2011, the entire contents of which are hereby incorporated by reference.

### BACKGROUND

The present disclosure relates to a display apparatus, and more particularly, to a display apparatus providing an image having uniform brightness.

Display apparatuses include a backlight unit for generating light, and a display panel using the light to display an image.

Display apparatuses for notebooks or mobile devices may include an edge-type backlight unit that has a light source and a light guide panel for guiding light from the light source to a display panel. The light source is adjacent to an edge of the light guide panel to emit light to the light guide panel, and the light guide panel guides the light to the display panel.

### SUMMARY

The present disclosure provides a display apparatus providing an image having uniform brightness.

Embodiments of the inventive concept provide display apparatuses, which include a light source unit providing light, a light guide panel guiding the light to a display panel receiving the light to display an image, and a bottom chassis accommodating the light guide panel, the light source unit, and the display panel.

The light guide panel may be adjacent to the light source unit, and include a light incident surface for receiving the light, a light output surface from which the light is emitted, and an opposite surface opposed to the light output surface. The display panel may face the light output surface and receive the light from the light output surface to display an image. The bottom chassis may have a bottom facing the opposite surface. The light guide panel may include a coupling member protruding from the opposite surface and coupled to the bottom chassis.

The display apparatuses may further include a fixing member coupled to the coupling member with the bottom chassis therebetween.

In some embodiments, the coupling member may include a male screw, the fixing member may include a female screw, and the coupling member may be screwed to the fixing member. The fixing member may include a pin, and the coupling member may have a pin hole in which the pin is inserted. The coupling member and the fixing member may be fixed by the pin inserted into the pin hole. The coupling member may have a bar shape on the opposite surface, and may be inserted in a recess of the bottom chassis and be fixed. The coupling member may include a hook, and the coupling member may hook the bottom chassis.

The light guide panel may be provided in plurality, and the light guide panels may include protrusions protruding from the light incident surfaces and covering an upper portion of the light source unit. The display apparatuses may further include a reflective member between the light source unit and the protrusions to reflect light emitted from the light source unit.

### BRIEF DESCRIPTION OF THE DRAWINGS

FIG. 1 is an exploded perspective view illustrating a display apparatus according to an embodiment of the inventive concept;

FIG. 2 is a partial exploded perspective view illustrating a portion of the display apparatus of FIG. 1;

FIG. 3 is a partial cross-sectional view taken along line I-I′ of FIG. 2;

FIG. 4 is a cross-sectional views illustrating a portion of a display apparatus according to another embodiment of the inventive concept;

FIG. 5 is a cross-sectional views illustrating a portion of a display apparatus according to another embodiment of the inventive concept;

FIG. 6 is a perspective view illustrating light guide panels of a display apparatus according to another embodiment of the inventive concept;

FIG. 7 is a cross-sectional view taken along line II-II′ of FIG. 6;

FIG. 8A is a graph illustrating a brightness distribution of a general display apparatus according to distances from a light source;

FIG. 8B is a graph illustrating a brightness distribution of the display apparatus of FIG. 6 according to distances from a light source;

FIG. 9 is a perspective view illustrating a portion of a display apparatus according to another embodiment of the inventive concept;

FIGS. 10A and 10B are cross-sectional views taken along line III-III′ of FIG. 9, which sequentially illustrate a process in which light guide panels are coupled to a bottom chassis;

FIG. 11 is a cross-sectional view illustrating a portion of a display apparatus according to another embodiment of the inventive concept;

FIG. 12 is a cross-sectional view illustrating a portion of a display apparatus according to another embodiment of the inventive concept;

FIG. 13 is a plan view illustrating arrangement of light guide panels and light sources in a display apparatus according to another embodiment of the inventive concept; and

FIG. 14 is a cross-sectional view taken along line IV-IV′ of FIG. 13.

### DETAILED DESCRIPTION

Since the inventive concept may have diverse modified embodiments, various embodiments are illustrated in the drawings and are described in the detailed description. However, this does not limit the inventive concept within specific embodiments and it should be understood that the inventive concept covers all the modifications, equivalents, and replacements within the idea and technical scope of the inventive concept.

Like reference numerals refer to like elements throughout. In the drawings, the dimensions and size of each structure are exaggerated, omitted, or schematically illustrated for convenience in description and clarity. It will be understood that although the terms of first and second are used herein to describe various elements, these elements should not be limited by these terms. Terms are only used to distinguish one component from other components. Therefore, a component referred to as a first component in one embodiment can be referred to as a second component in another embodiment. The terms of a singular form may include plural forms unless referred to the contrary.

The meaning of ‘comprise’, ‘include’, or ‘have’ specifies a property, a region, a fixed number, a step, a process, an element and/or a component, but does not exclude other properties, regions, fixed numbers, steps, processes, elements and/or components. In the specification, it will be understood that when a layer (or film), a region, or a plate is referred to as being ‘on’ another layer, region, or plate, it can be directly on the other layer, region, or plate, or intervening layers, regions, or plates may also be present. In the specification, it will be understood that when a layer (or film), a region, or a plate is referred to as being ‘under’ another layer, region, or plate, it can be directly under the other layer, region, or plate, or intervening layers, regions, or plates may also be present.

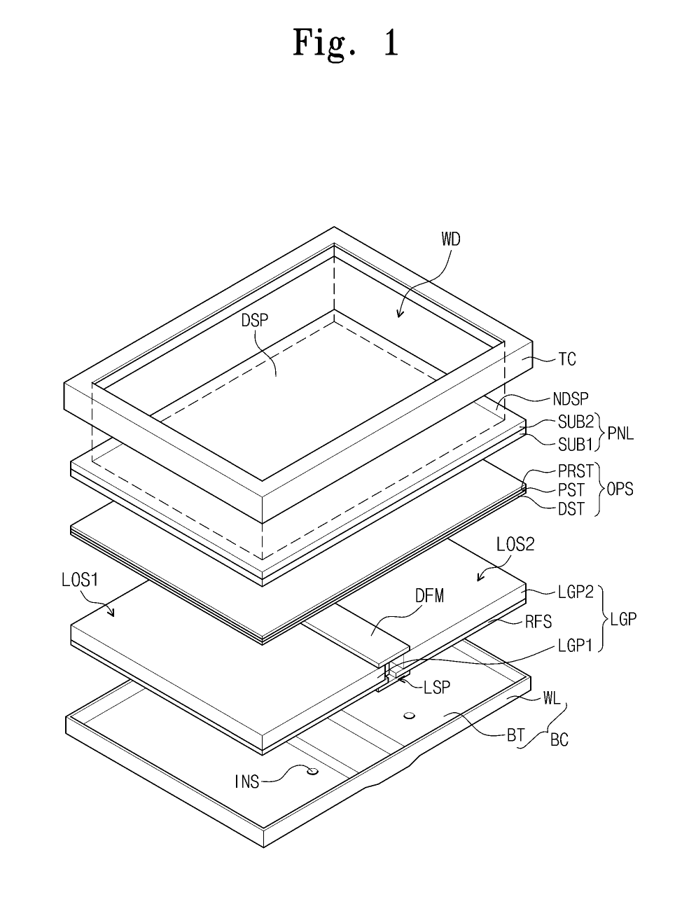

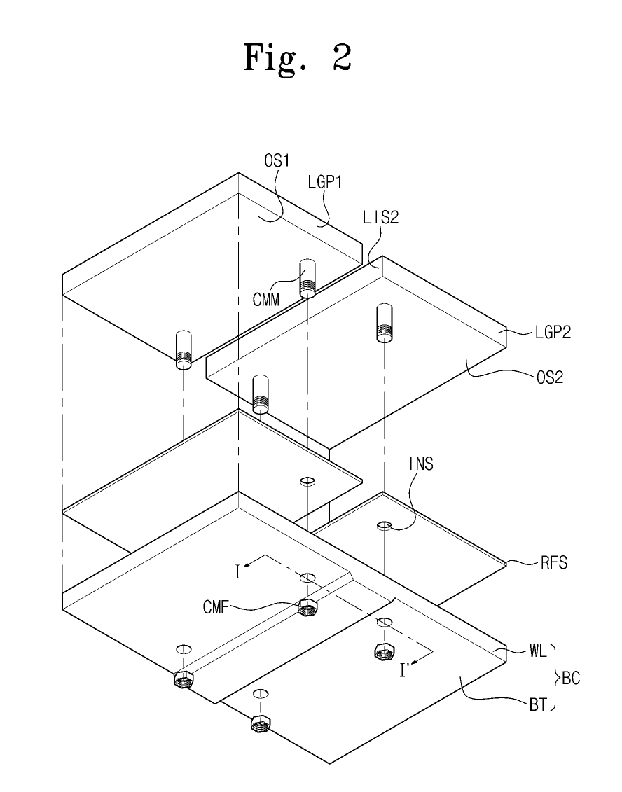

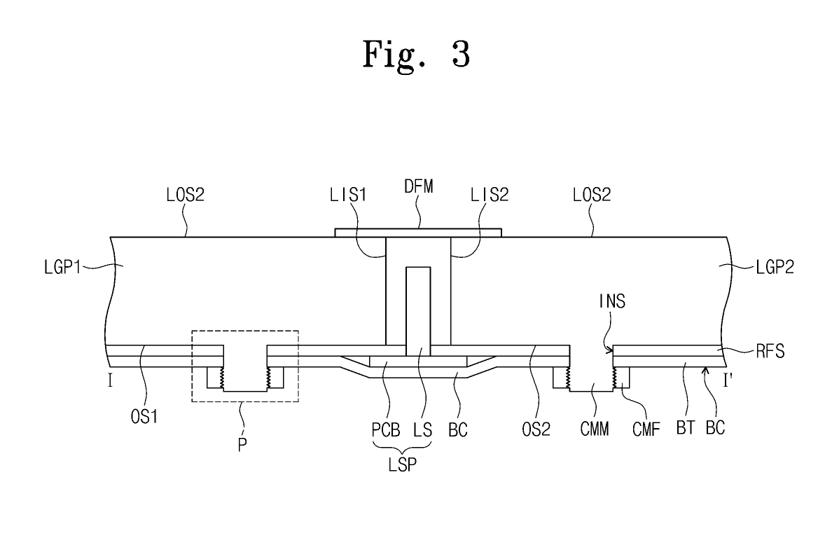

FIG. 1 is an exploded perspective view illustrating a display apparatus according to an embodiment of the inventive concept. FIG. 2 is a partial exploded perspective view illustrating the lower portion of a backlight assembly constituting the display apparatus of FIG. 1. FIG. 3 is a partial cross-sectional view taken along line I-I′ of FIG. 2. A light source is omitted in FIG. 2, for convenience in description.

Referring to FIGS. 1 through 3, the display apparatus includes a display panel PNL, a backlight assembly, a bottom chassis BC, and a top chassis TC.

The display panel PNL is configured to display an image. The display panel PNL is a non-emissive display panel, which is one of various display panels such as a liquid crystal display panel and an electrophoretic display panel. In the current embodiment, a liquid crystal display panel is exemplified as the display panel PNL.

The display panel PNL has a rectangular plate shape with a pair of long sides and a pair of short sides. The display panel PNL includes a first substrate SUB1, a second substrate SUB2 facing the first substrate SUB1, and a liquid crystal layer (not shown) disposed between the first and second substrates SUB1 and SUB2. When viewed from a plan view, the display panel PNL includes a display region DSP for displaying an image, and a non-display region NDSP surrounding the periphery of the display region DSP. The non-display region NDSP is hidden by the top chassis TC.

According to an embodiment of the inventive concept, the first substrate SUB1 may include a plurality of pixel electrodes (not shown) and a plurality of thin film transistors (not shown) that are in one-to-one correspondence to the pixel electrodes, and that are electrically connected thereto. Each thin film transistor is configured to switch a driving signal that is provided to the corresponding pixel electrode. The second substrate SUB2 may include a common electrode (not shown). The common electrode and the pixel electrodes form an electric field to control the arrangement of liquid crystals. The display panel PNL drives the liquid crystal layer to display an image.

The backlight assembly emits light to the display panel PNL, and is disposed under the display panel PNL. The backlight assembly includes a light source unit LSP including light sources LS for emitting light, light guide panels LGP guiding the light to the display panel PNL, optical sheets OPS for improving the efficiency of the light, and a reflective sheet RFS changing a travelling direction of the light.

Referring to FIGS. 1 through 3, the light source unit LSP is adjacent to the light guide panels LGP to provide light thereto.

One light source unit as the light source unit LSP may be provided as illustrated in FIGS. 1 and 3, but the inventive concept is not limited thereto, and thus, the light source unit LSP may be provided in plurality. The light guide panel LGP may be provided in plurality as illustrated in FIGS. 1 and 3, but the inventive concept is not limited thereto, and thus, one light guide panel may be provided. For example, one light guide panel and one light source unit disposed at a side of the light guide panel may be provided, or a plurality of light guide panels and a plurality of light guide units disposed between and around the light guide panels may be provided.

According to the following embodiments of the inventive concept, the light guide panel LGP is provided in plurality, more particularly, in two, and the light source unit LSP is provided in single, which disposed between the two light guide panels LGP.

The optical sheets OPS are disposed between the display panel PNL and the light guide panels LGP. The optical sheets OPS control light emitted from the light sources LS. The optical sheets OPS include a diffusion sheet DST, a prism sheet PST, and a protective sheet PRST, which are stacked on the light guide panels LGP.

The diffusion sheet DST diffuses light. The prism sheet PST collects the light diffused by the diffusion sheet DST in a direction perpendicular to the display panel PNL. Most of the light emitted from the prism sheet PST is perpendicularly to the display panel PNL. The protective sheet PRST is disposed on the prism sheet PST. The protective sheet PRST protects the prism sheet PST against external shock. In the current embodiment, the optical sheets OPS include one diffusion sheet as the diffusion sheet DST, one prism sheet as the prism sheet PST, and one protective sheet as the protective sheet PRST, but the inventive concept is not limited thereto. At least one of the diffusion sheet DST, the prism sheet PST, and the protective sheet PRST may be provided in plurality to the optical sheets OPS, or one or more of the diffusion sheet DST, the prism sheet PST, and the protective sheet PRST may be omitted. The diffusion sheet DST, the prism sheet PST, and the protective sheet PRST may change their positions.

The reflective sheet RFS reflects light back to the display panel PNL, and is disposed under the light guide panels LGP. The reflective sheet RFS is disposed on the bottom chassis BC. Thus, the reflective sheet RFS increases the amount of light provided to the display panel PNL.

The top chassis TC is disposed over the display panel PNL. The top chassis TC supports upper edges of the display panel PNL, and may cover side surfaces of a mold frame or the bottom chassis BC. The top chassis TC includes a display window WD exposing the display region DSP of the display panel PNL.

The bottom chassis BC is disposed under the backlight assembly to accommodate the display panel PNL and components of the backlight assembly. The bottom chassis BC may include a bottom BT parallel to the rear surface of the reflective sheet RFS, and one or more sidewalls WL bent from the bottom BT and extending upward. The display panel PNL and the backlight assembly are accommodated in a space defined by the bottom BT and the sidewall WL.

Referring to FIGS. 2 and 3, the display apparatus according to the current embodiment includes a first light guide panel LGP1 and a second light guide panel LGP2. According to another embodiment of the inventive concept, a display apparatus may include three or more light guide panels that may be arrayed on a single line in a predetermined direction, or be arrayed in a mosaic pattern. In this case, two neighboring light guide panels of the three light guide panels may be the first and second light guide panels LGP1 and LGP2, respectively.

The first and second light guide panels LGP1 and LGP2 are spaced apart from each other such that first and second light incident surfaces LIS1 and LIS2 of the first and second light guide panels LGP1 and LGP2 face each other with the light source unit LSP therebetween. That is, the light source unit LSP is disposed in a space between the first and second light guide panels LGP1 and LGP2. The light source unit LSP generates light that is used for the display panel PNL to display an image.

The light source unit LSP includes the light sources LS and a printed circuit board PCB on which the light sources LS are mounted. The printed circuit board PCB supports the light sources LS from the lower side, and supplies power to the light sources LS. The printed circuit board PCB may have a plate shape extending in a predetermined direction according to an array direction of the light sources LS. When the light sources LS are arrayed in a predetermined array direction the printed circuit board PCB may extend in the array direction.

In the current embodiment, the light source unit LSP includes the printed circuit board PCB and the light sources LS, but the inventive concept is not limited thereto. That is, the printed circuit board PCB may be removed. In this case, at least one of a separate support for supporting the light sources LS and a separate line for supplying power to the light sources LS may be provided.

The light sources LS may include a point light source, a line light source, or a surface light source, but the inventive concept is not limited thereto. In the current embodiment, light emitting diodes (LEDs) are exemplified as the light sources LS.

Although not shown, each of the light sources LS includes a support and a light emitting device. The support has a plate shape with a front surface and a rear surface. The support may include a high polymer insulating material such as an epoxy resin or an acrylic resin. However, the inventive concept is not limited thereto, and thus, the support may be any structure, provided that the light emitting device can be mounted thereon. The light emitting device emits light, and is a light emitting diode mounted on the front surface of the support. The front surface of the support functions as a light emitting surface of each light source LS.

The light guide panels LGP are disposed under the display panel PNL to guide light emitted from the light source unit LSP to the display panel PNL. Each of the light guide panels LGP has an approximately tetragonal plate shape from a plan view. Each side of the tetragonal plate shape may be parallel to one of the short and long sides of the display panel PNL. The first and second light guide panels LGP1 and LGP2 are disposed on an identical plane that is parallel to a surface of the display panel PNL.

The first light guide panel LGP1 includes the first light incident surface LIS1 receiving light from the light sources LS, a first light output surface LOS1 emitting the light, and a first opposite surface OS1 opposed to the first light output surface LOS1. The first light incident surface LIS1 faces the light sources LS. The first light output surface LOS1 faces the bottom surface of the display panel PNL. The first opposite surface OS1 faces the bottom BT of the bottom chassis BC to be described later.

The second light guide panel LGP2 includes the second light incident surface LIS2 receiving light from the light sources LS, a second light output surface LOS2 emitting the light, and a second opposite surface OS2 opposed to the second light output surface LOS2. The second light incident surface LIS2 faces the light sources LS. The second light output surface LOS2 faces the bottom surface of the display panel PNL. The second opposite surface OS2 faces the bottom BT of the bottom chassis BC.

Although not shown, the first and second opposite surfaces OS1 and OS2 may include diffusion patterns for diffusing light. The diffusion patterns are formed of a material for diffusing light, and may be printed on the first and second opposite surfaces OS1 and OS2. The diffusion pattern may be a recess patterned using laser. The diffusion pattern may have a uniform density in the first and second opposite surfaces OS1 and OS2, but the inventive concept is not limited thereto. For example, the density of the diffusion pattern may vary according to a distance from the light source unit LSP.

According to the current embodiment, each of the light guide panels LGP is fixed to the bottom chassis BC by first fixing members CMF. Each of the light guide panels LGP includes first coupling members CMM that are coupled to the bottom chassis BC and the first fixing members CMF. The first coupling members CMM have a protrusion shape vertically protruding from the first and second opposite surfaces OS1 and OS2. The first coupling members CMM may have a cylindrical shape or a polygonal column shape. In the current embodiment, the first coupling members CMM have a cylindrical shape. The first coupling members CMM may be integrally formed with each of the light guide panels LGP. In this case, the light guide panel LGP and the first coupling members CMM may be formed using injection molding.

An end of the first coupling members CMM may have a thread in the form of a male screw, so that the first coupling members CMM can be screwed to the first fixing members CMF.

The reflective sheets RFS and the bottom chassis BC may have insertion holes INS at positions corresponding to the positions of the first coupling members CMM of the light guide panels LGP. The first coupling members CMM are inserted into the insertion holes INS. The insertion holes INS have a size corresponding to a diameter of the first coupling members CMM to facilitate the inserting of the first coupling members CMM.

The first coupling members CMM are inserted into the insertion holes INS, and the ends of the first coupling members CMM protrude to the lower side of the bottom chassis BC. The first fixing members CMF are provided in the form of a female screw, and are screwed to the ends of the first coupling members CMM protruding to the lower side of the bottom chassis BC. Accordingly, the first fixing members CMF securely couple the light guide panels LGP with the bottom chassis BC.

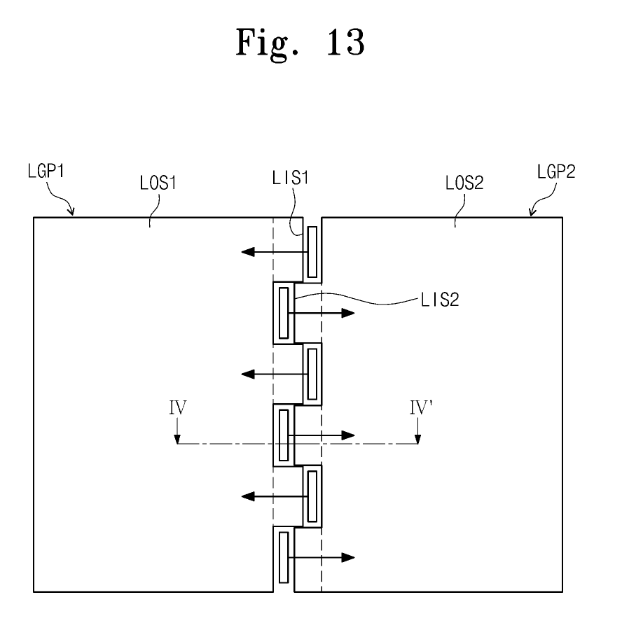

Coupling of the light source unit LSP and the first and second light guide panels LGP1 and LGP2, and a travelling path of light emitted from the light source unit LSP will now be described. The light source unit LSP is disposed between the first and second light guide panels LGP1 and LGP2. The light source unit LSP includes first light sources LS having light emitting surfaces that face the first light incident surface LIS1 of the first light guide panel LGP1, and second light sources LS having light emitting surfaces that face the second light incident surface LIS2 of the second light guide panel LGP2. The first light sources are arrayed alternately with the second light sources (see FIG. 13 for example). Light generated from the first light sources is emitted to the first light guide panel LGP1, and light generated from the second light sources is emitted to the second light guide panel LGP2.

Light incident from the light source unit LSP to the first light incident surface LIS1 is reflected and refracted at a plurality of times in the first light guide panel LGP1, and is emitted to the display panel PNL through the first light output surface LOS1. Light incident from the light source unit LSP to the second light incident surface LIS2 is reflected and refracted at a plurality of times in the second light guide panel LGP2, and is emitted to the display panel PNL through the second light output surface LOS2.

According to an embodiment of the inventive concept, the first light sources may be driven independently from the second light sources, and thus, the amount of light provided to the first light guide panel LGP1 may be different from the amount of light provided to the second light guide panel LGP2. Thus, the amount of light emitted to the display panel PNL through the first light guide panel LGP1 may be different from the amount of light emitted to the display panel PNL through the second light guide panel LGP2 according to the position of a display region of the display panel PNL, so that the display apparatus can be driven in a so-called local dimming manner.

A diffusion member DFM may be disposed between the first and second light guide panels LGP1 and LGP2 to cover the light source unit LSP from the upper side, thereby diffusing light to be emitted to the display panel PNL between the first and second light guide panels LGP1 and LGP2. When light is emitted from the light source unit LSP to the display panel PNL between the first and second light guide panels LGP1 and LGP2, an image displayed on the display panel PNL may have uneven brightness. However, according to the current embodiment, the diffusion member DFM covers the light source unit LSP between the first and second light guide panels LGP1 and LGP2 to diffuse leaking light emitted therebetween. Accordingly, brightness of an image displayed on the display panel PNL can be prevented from varying in the display region. Thus, the display apparatus according to the current embodiment displays an image having uniform brightness.

According to the current embodiment, since the light guide panels LGP are stably accommodated in the bottom chassis BC, a defect due to a movement of the light guide panels LGP can be prevented. Since the light guide panels LGP including the first coupling members CMM can be easily formed using injection molding, a process of manufacturing the display apparatus is simplified.

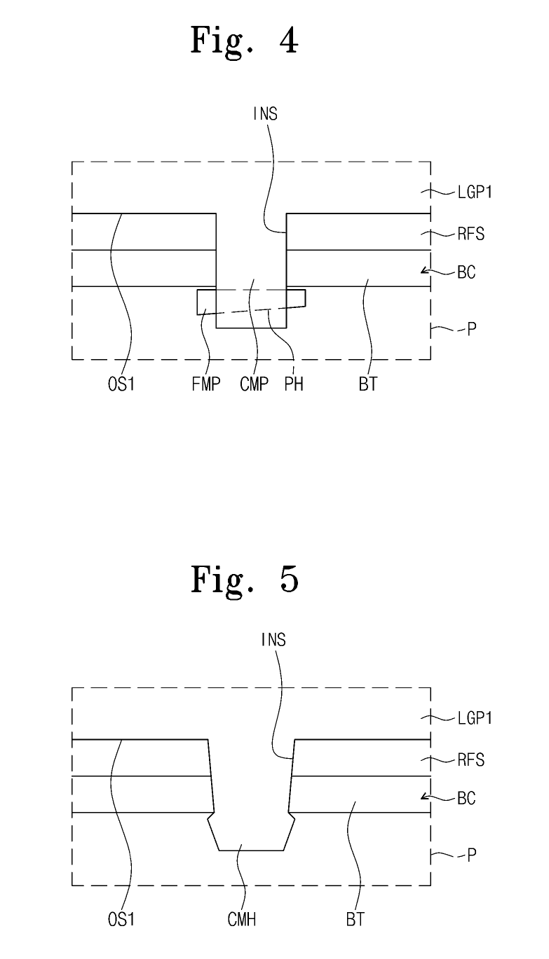

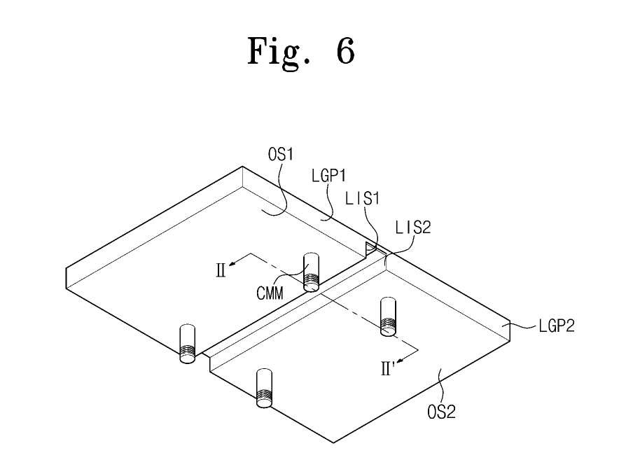

According to embodiments of the inventive concept, the light guide panels LGP can be fixed to the bottom chassis BC under one of various structures. FIGS. 4 and 5 are cross-sectional views illustrating a portion of a display apparatus according to embodiments of the inventive concept, which correspond to a region P of FIG. 3. Since the embodiments of FIGS. 4 and 5 have the same parts as that of the previous embodiment of FIG. 3, a description thereof will be omitted. Like reference numerals refer to like elements, for convenience in description.

Referring to FIGS. 1 through 4, in the display apparatus according to the embodiment of FIG. 4, a light guide panel LGP1 is fixed by a second fixing member FMP having a pin shape, with the bottom chassis BC therebetween.

Each of the light guide panels LGP (the first light guide panel LGP1 in FIG. 4) includes a second coupling member CMP that is coupled to the bottom chassis BC and the second fixing member FMP. The second coupling member CMP has a protrusion shape protruding vertically from the first and second opposite surfaces OS1 and OS2. The second coupling member CMP may have a cylindrical shape or a polygonal column shape. The second coupling member CMP may be integrally formed with each of the light guide panels LGP. In this case, the light guide panel LGP and the second coupling member CMP may be formed using injection molding.

An end of the second coupling member CMP is provided with a pin hole PH through which the second fixing member FMP having a pin shape is inserted. The pin hole PH passes through the second coupling member CMP in a direction substantially parallel to the first and second opposite surfaces OS1 and OS2, so that the second fixing member FMP can be inserted into the direction substantially parallel to the first and second opposite surfaces OS1 and OS2. The pin hole PH has an inner diameter corresponding to a diameter of the second fixing member FMP.

The reflective sheet RFS and the bottom chassis BC include the insertion hole INS at a position corresponding to the position of the second coupling member CMP of each of the light guide panels LGP. The second coupling member CMP is inserted into the insertion hole INS. The insertion hole INS has a size corresponding to a diameter of the second coupling member CMP to facilitate the inserting of the second coupling member CMP.

The second coupling member CMP is inserted into the insertion hole INS, and the end of the second coupling member CMP protrudes to the lower side of the bottom chassis BC. The second fixing member FMP is provided in the form of a pin, and is inserted into the pin hole PH in the end of the second coupling member CMP protruding to the lower side of the bottom chassis BC. The second fixing member FMP is inserted into the direction substantially parallel to the first and second opposite surfaces OS1 and OS2, and thus, the second fixing member FMP is coupled to the light guide panel LGP with the bottom chassis BC therebetween, and the light guide panel LGP is securely fixed to the bottom chassis BC.

Referring to FIGS. 1, 2, 3, and 5, in the display apparatus according to the embodiment of FIG. 5, each of the light guide panels LGP (a first light guide panel LGP1 in FIG. 5) is fixed to the bottom chassis BC by a third coupling member CMH having a hook shape.

Each of the light guide panels LGP includes the third coupling member CMH that is coupled to the bottom chassis BC. The third coupling members CMH may protrude from the first and second opposite surfaces OS1 and OS2 and include a catching protrusion or hook and a column having one of various shapes such as a cylindrical shape and a polygonal column shape. The third coupling member CMH may be integrally formed with each of the light guide panels LGP. In this case, the light guide panel LGP and the third coupling member CMH may be formed using injection molding.

The reflective sheet RFS and the bottom chassis BC include the insertion holes INS at a position corresponding to the position of the third coupling member CMH of each of the light guide panels LGP. The third coupling member CMH is inserted into the insertion hole INS. The insertion hole INS has a size corresponding to a diameter of the third coupling member CMH to facilitate the inserting of the third coupling member CMH.

The third coupling member CMH inserted into the insertion hole INS is not removed from the bottom chassis BC since the catching protrusion catches the insertion hole INS. Accordingly, the third coupling member CMH securely fixes each of the light guide panels LGP to the bottom chassis BC.

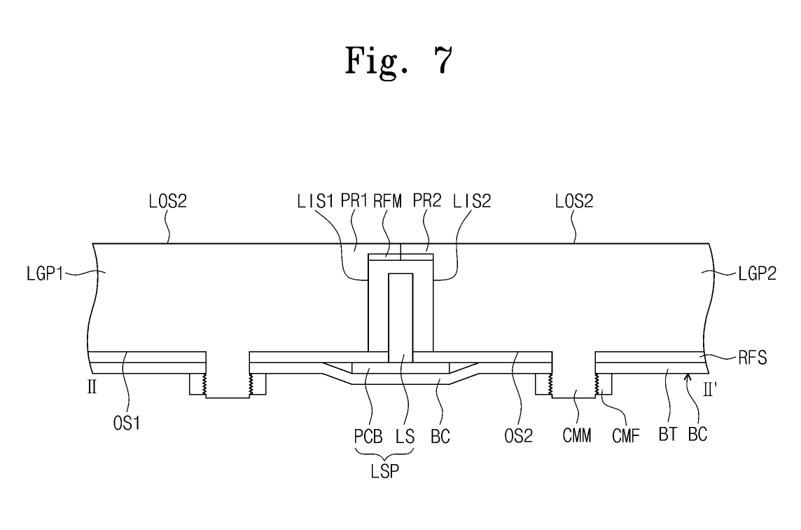

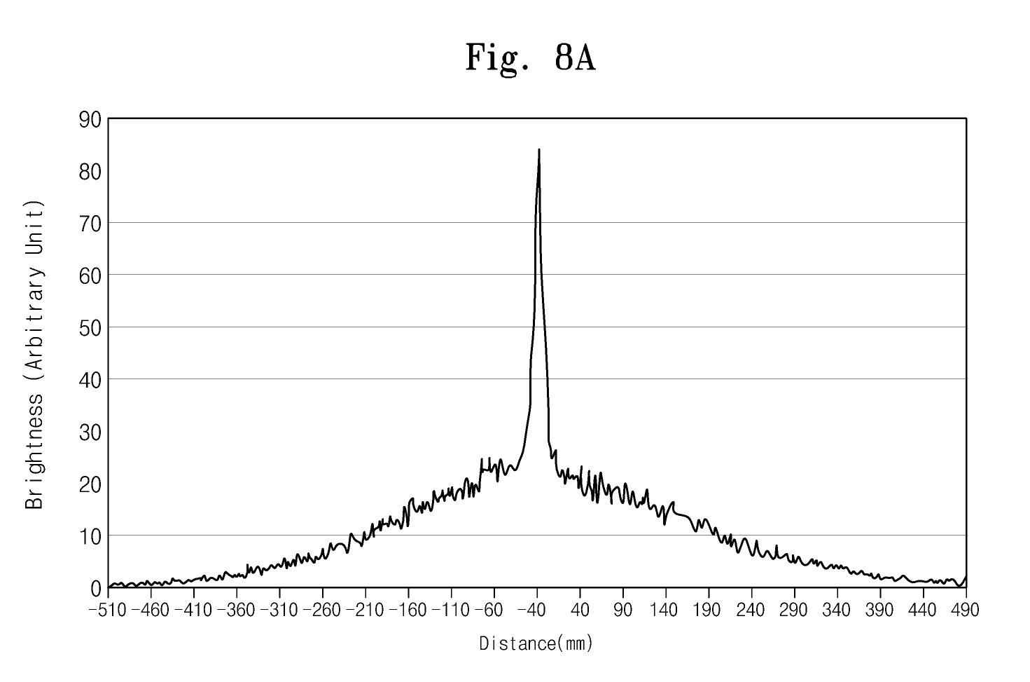

According to embodiments of the inventive concept, the light guide panels LGP may have various shapes. FIG. 6 is a perspective view illustrating first and second light guide panels LGP1 and LGP2 of a display apparatus according to another embodiment of the inventive concept. FIG. 7 is a cross-sectional view taken along line II-II′ of FIG. 6. Since the embodiment of FIG. 6 has the same part as that of the previous embodiment of FIG. 3, a description thereof will be omitted. Like reference numerals refer to like elements, for convenience in description.

Referring to FIGS. 1, 2, 3, 6, and 7, each of the first and second light guide panels LGP1 and LGP2 includes a protrusion that protrudes from light incident surfaces thereof to cover the upper portion of the light source unit LSP.

In detail, the first light guide panel LGP1 includes the first light incident surface LIS1 receiving light from the light sources LS, the first light output surface LOS1 emitting light, and the first opposite surface OS1 opposed to the first light output surface LOS1. The first light incident surface LIS1 faces the light sources LS. The first light output surface LOS1 faces the bottom surface of the display panel PNL. The first opposite surface OS1 faces the bottom BT of the bottom chassis BC to be described later.

The second light guide panel LGP2 includes the second light incident surface LIS2 receiving light from the light sources LS, the second light output surface LOS2 emitting the light, and the second opposite surface OS2 opposed to the second light output surface LOS2. The second light incident surface LIS2 faces the light sources LS. The second light output surface LOS2 faces the bottom surface of the display panel PNL. The second opposite surface OS2 faces the bottom BT of the bottom chassis BC.

The first light guide panel LGP1 includes a first protrusion PR1 protruding from the first light incident surface LIS1. The second light guide panel LGP2 includes a second protrusion PR2 protruding from the second light incident surface LIS2. The first protrusion PR1 protrudes in a direction parallel to the first light output surface LOS1. The top surface of the first protrusion PR1 is an extension of the first light output surface LOS1. The second protrusion PR2 protrudes in a direction parallel to the second light output surface LOS2. The top surface of the second protrusion PR2 is an extension of the second light output surface LOS2. The first protrusion PR1 contacts the second protrusion PR2, and there is no space therebetween. Accordingly, the first and second protrusions PR1 and PR2 cover the space between the first and second light guide panels LGP1 and LGP2.

A reflective member RFM may be disposed between the light source unit LSP and the first and second protrusions PR1 and PR2 to reflect light emitted from the light source unit LSP. The reflective member RFM may be attached to the bottom surfaces of the first and second protrusions PR1 and PR2. The reflective member RFM may include a material having high reflectivity, such as silver.

Leaking light emitted between the first and second light guide panels LGP1 and LGP2 from the light source unit LSP to the display region DSP of the display panel PNL, is not guided by the first and second light guide panels LGP1 and LGP2. In this case, due to the leaking light, brightness of an image displayed on the display panel PNL may vary in the display region DSP. However, according to the current embodiment, the reflective member RFM covers the light source unit LSP between the first and second light guide panels LGP1 and LGP2 to reflect the leaking light downward. Accordingly, brightness of an image displayed on the display panels PNL can be prevented from varying in the display region DSP.

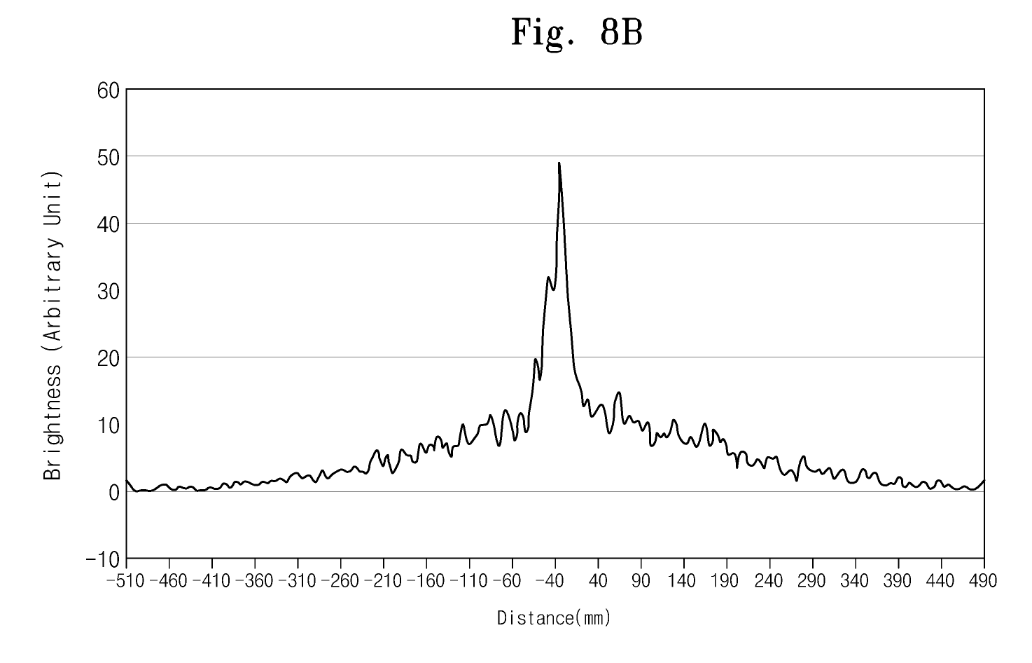

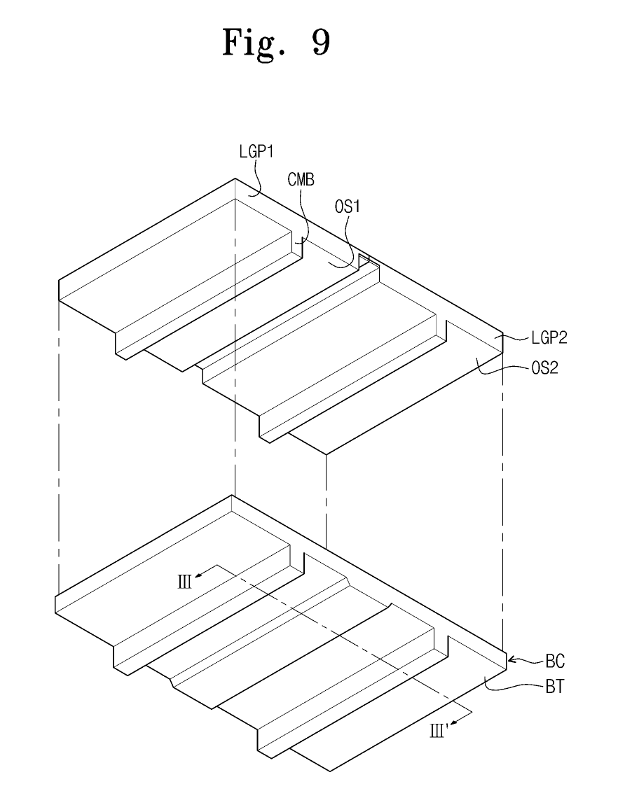

FIG. 8A is a graph illustrating a brightness distribution of a general display apparatus according to distances from a light source, in which a light source unit is disposed between two adjacent light guide panels.

FIG. 8B is a graph illustrating a brightness distribution of a display apparatus according to the embodiment of FIG. 6 according to distances from a light source, in which a light source unit is disposed between two adjacent light guide panels. Protrusions are disposed on light incident surfaces of the light guide panels, and a reflective member is disposed between the light source unit and the protrusions.

An x-axis in FIGS. 8A and 8B denotes distances from the light source, and a y-axis denotes brightness in an arbitrary unit.

Referring to FIGS. 8A and 8B, while the general display apparatus has very high brightness on the vertical upper side of the light source unit, the display apparatus according to the embodiment of FIG. 6 has smaller brightness than the general display apparatus does on the vertical upper side of the light source unit. Thus, the brightness of the display apparatus according to the embodiment of FIG. 6 is reduced on the vertical upper side of the light source unit, so that the display apparatus can have more uniform brightness.

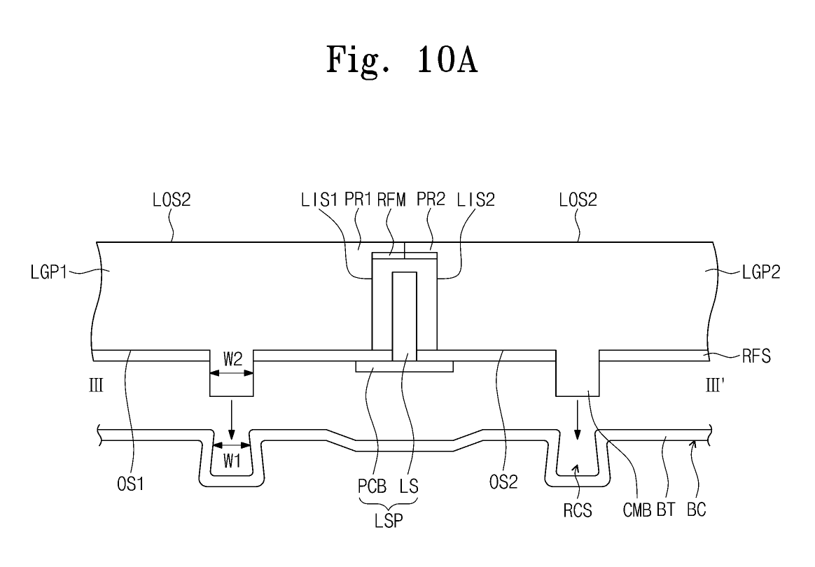

FIG. 9 is a perspective view illustrating a portion of a display apparatus according to another embodiment of the inventive concept. Since the embodiment of FIG. 9 has the same generally parts as those of the previous embodiments, a description thereof will be omitted. Like reference numerals refer to like elements, and a reflective sheet and a light source unit are omitted in FIG. 9, for convenience in description.

According to the current embodiment, each of first and second light guide panels LGP1 and LGP2 includes a fourth coupling member CMB coupled to the bottom chassis BC. The fourth coupling members CMB vertically protrude from the first and second opposite surfaces OS1 and OS2 and extend in a bar shape in a predetermined extension direction on the first and second opposite surfaces OS1 and OS2. The fourth coupling member CMB may be integrally formed with each of the first and second light guide panels LGP1 and LGP2. In this case, the first and second light guide panels LGP1 and LGP2 may be formed using injection molding.

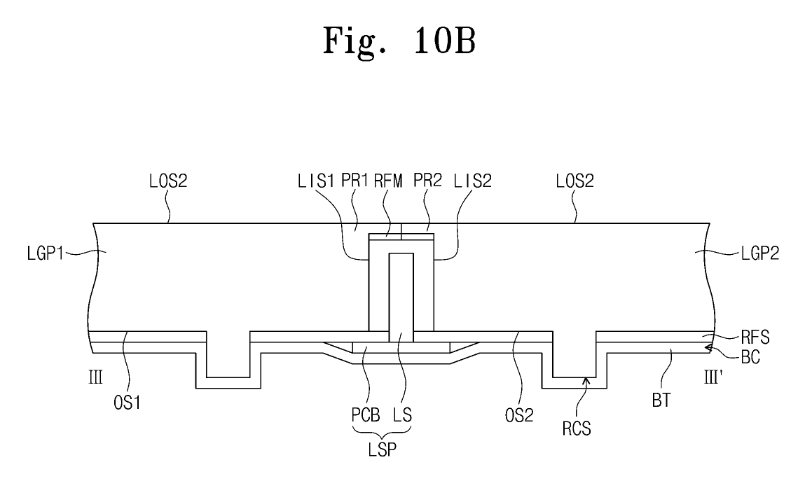

The bottom chassis BC has recesses RCS (refer to FIG. 10A) at positions corresponding to the positions of the fourth coupling members CMB. The fourth coupling members CMB are inserted in the recesses RCS. The recesses RCS are recessed downward from the bottom BT of the bottom chassis BC. The recesses RCS have a size corresponding to a width of the fourth coupling members CMB to facilitate the inserting of the fourth coupling members CMB.

When the fourth coupling members CMB extend in the extension direction on the first and second opposite surfaces OS1 and OS2, the recesses RCS has a width W1 (refer to FIG. 10A) perpendicular to the extension direction and parallel to the first and second opposite surfaces OS1 and OS2, and the fourth coupling members CMB have a width W2 (refer to FIG. 10A) perpendicular to the extension direction and parallel to the first and second opposite surfaces OS1 and OS2. The width W1 is smaller than the width W2. Accordingly, the fourth coupling members CMB inserted in the recesses RCS are fixed by elastic force of the bottom chassis BC.

FIGS. 10A and 10B are cross-sectional views taken along line III-III′ of FIG. 9, which sequentially illustrate a process in which the first and second light guide panels LGP1 and LGP2 are coupled to the bottom chassis BC. Referring to FIGS. 10A and 10B, the fourth coupling members CMB are inserted in the recesses RCS of the bottom chassis BC, and thus, the first and second light guide panels LGP1 and LGP2 are fixed to the bottom chassis BC.

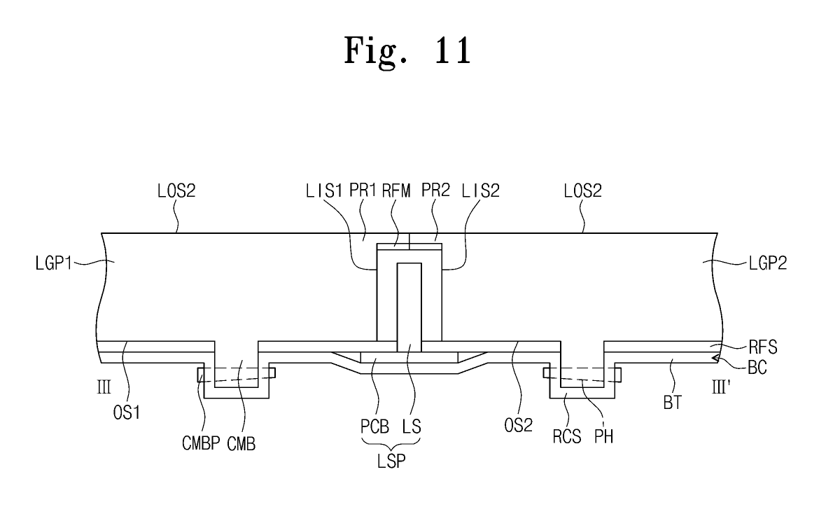

In the current embodiment, the fourth coupling members CMB are fixed to the bottom chassis BC by the elastic force of the bottom chassis BC, but the inventive concept is not limited thereto. FIG. 11 is a cross-sectional view illustrating a portion of a display apparatus according to another embodiment of the inventive concept. In the current embodiment, the fourth coupling members CMB are fixed to the bottom chassis BC by separate third fixing members CMBP having a pin shape.

Referring to FIG. 11, each of first and second light guide panels LGP1 and LGP2 includes the fourth coupling member CMB coupled to the bottom chassis BC. The fourth coupling members CMB vertically protrude from the first and second opposite surfaces OS1 and OS2 and extend in a bar shape in the extension direction on the first and second opposite surfaces OS1 and OS2. The fourth coupling member CMB may be integrally formed with each of the first and second light guide panels LGP1 and LGP2. In this case, each of the first and second light guide panels LGP1 and LGP2 and the fourth coupling member CMB may be formed using injection molding.

The bottom chassis BC has recesses RCS at positions corresponding to the positions of the fourth coupling members CMB. The fourth coupling members CMB are inserted in the recesses RCS. The recesses RCS are recessed downward from the bottom BT of the bottom chassis BC. The recesses RCS correspond to the fourth coupling members CMB, so that the fourth coupling members CMB can be inserted in the recesses RCS.

The bottom chassis BC and the recesses RCS have the pin holes PH through which the third fixing members CMBP having a pin shape are inserted. The pin holes PH pass through the bottom chassis BC and the recesses RCS in a direction substantially parallel to the first and second opposite surfaces OS1 and OS2, so that the third fixing members CMBP having a pin shape can be inserted in the direction substantially parallel to the first and second opposite surfaces OS1 and OS2. The pin holes PH have an inner diameter corresponding to a diameter of the third fixing members CMBP.

Accordingly, the fourth coupling members CMB are inserted in the recesses RCS and are fixed to the bottom chassis BC by the third fixing members CMBP.

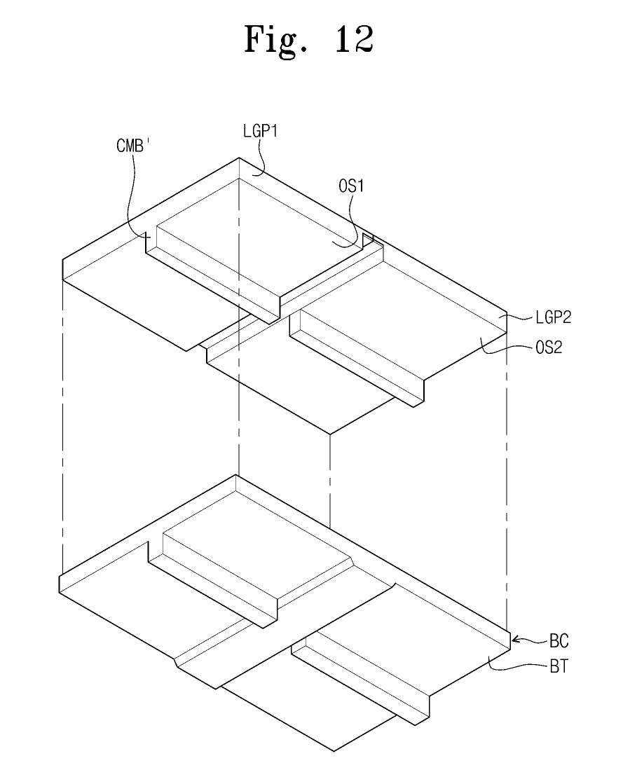

The fourth coupling members CMB may extend in any direction different from the extension direction in the embodiment of FIG. 9. FIG. 12 is a perspective view illustrating a portion of a display apparatus according to another embodiment of the inventive concept. The current embodiment is substantially the same as the embodiment of FIG. 9, except for an extension direction of fourth coupling members CMB′ and an extension direction of recesses RCS of the bottom chassis BC.

According to embodiments of the inventive concept, the fourth coupling members CMB′ may extend in a direction parallel to a side of first and second light guide panels LGP1 and LGP2. For example, when each of the first and second light guide panels LGP1 and LGP2 has a rectangular shape with long sides and short sides, the fourth coupling members CMB extends in the extension direction of long sides of the first and second light guide panels LGP1 and LGP2 in the embodiment of FIG. 9, and the fourth coupling members CMB′ extend in the extension direction of short sides of the first and second light guide panels LGP1 and LGP2 in the current embodiment. That is, the fourth coupling members CMB′ may extend in the extension direction of one of the long or short sides.

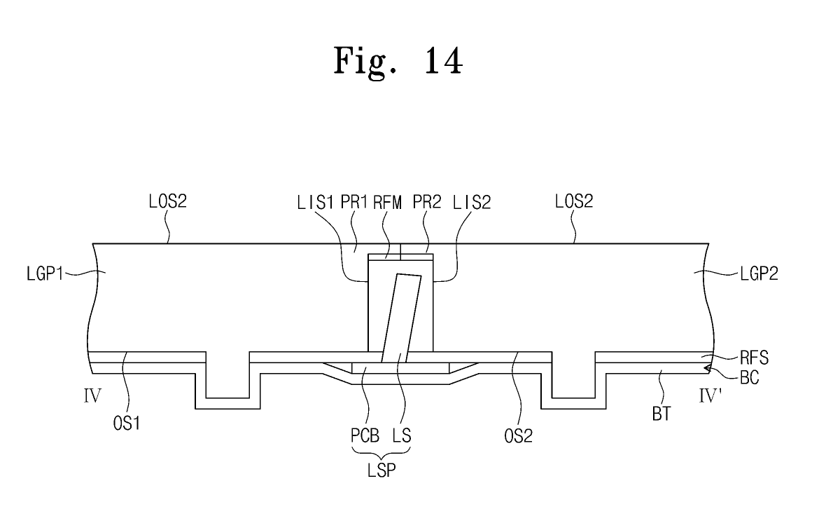

The light guide panels LGP and the light source unit LSP of the display apparatuses according to the above-described embodiments may be provided in various forms. FIG. 13 is a plan view illustrating arrangement of light guide panels and light sources in a display apparatus according to another embodiment of the inventive concept. FIG. 14 is a cross-sectional view taken along line IV-IV′ of FIG. 13.

Referring to FIGS. 13 and 14, the display apparatus according to the current embodiment includes a first light guide panel LGP1 and a second light guide panel LGP2. The first and second light guide panels LGP1 and LGP2 are spaced apart from each other with a light source unit LSP therebetween.

Each of the first and second light guide panels LGP1 and LGP2 has an approximately rectangular shape with a pair of long sides and a pair of short sides, from a plan view. The first light guide panel LGP1 includes first light incident surfaces LIS1 receiving light from the light sources LS. The second light guide panel LGP2 includes second light incident surfaces LIS2 receiving light from the light sources LS. The first light incident surfaces LIS1 are alternatively arrayed with the second light incident surfaces LIS2, and disposed on a different plane from that of the second light incident surfaces LIS2.

The light sources LS include: first light sources LS1 with light emitting surfaces that face the first light incident surfaces LIS1; and second light sources LS2 with light emitting surfaces that face the second light incident surfaces LIS2. The light emitting surfaces of the first light sources LS1 are in one-to-one correspondence to the first light incident surfaces LIS1, and the light emitting surfaces of the second light sources LS2 are in one-to-one correspondence to the second light incident surfaces LIS2.

As described above, since the first and second light sources LS1 and LS2 correspond to the first and second light incident surfaces LIS1 and LIS2 which are alternately arrayed on the different planes, dark regions between the first light sources LS1 and dark regions between the second light sources LS2 are reduced.

The first light sources LS1 may be inclined toward the first light guide panel LGP1, and the second light sources LS2 may be inclined toward the second light guide panel LGP2. In other words, the light emitting surfaces of the first light sources LS1 facing the first light incident surfaces LIS1 of the first light guide panel LGP1 may be inclined toward an opposite side to the display panel. As such, when the light emitting surfaces of the first light sources LS1 are inclined toward the opposite side to the display panel to provide light to the first light incident surfaces LIS1, the intensity of light passing between the first and second light guide panels LGP1 and LGP2 can be decreased, and the amount of light incident to the first light incident surfaces LIS1 can be increased. In a same manner, the light emitting surfaces of the second light sources LS2 facing the second light incident surfaces LIS2 of the second light guide panel LGP2 may be inclined toward the opposite side to the display panel.

According to the embodiments of the inventive concept, since the amount of light leaking between the adjacent light guide panels can be reduced, the display apparatus can display an image having uniform brightness. In addition, since the light guide panels are securely fixed to the bottom chassis and are stably accommodated therein, a defect due to a movement of light guide panels can be prevented.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A display apparatus comprising:
a light source unit providing light;
a light guide panel adjacent to the light source unit and including a light incident surface to which the light is incident, a light output surface from which the light is emitted, and an opposite surface opposed to the light output surface;
a display panel facing the light output surface and receiving the light to display an image; and
a bottom chassis accommodating the light guide panel, the light source unit, and the display panel, the bottom chassis having a bottom facing the opposite surface,
wherein the light guide panel includes a coupling member protruding from the opposite surface and coupled to the bottom chassis.

2. The display apparatus of claim 1, wherein the bottom chassis comprises an insertion hole into which the coupling member is inserted.

3. The display apparatus of claim 2, further comprising a fixing member coupled to the coupling member with the bottom chassis therebetween.

4. The display apparatus of claim 3, wherein the coupling member comprises a male screw, the fixing member comprises a female screw which is coupled to the male screw.

5. The display apparatus of claim 3, wherein the fixing member comprises a pin, and the coupling member comprises a pin hole in which the pin is inserted.

6. The display apparatus of claim 1, wherein the bottom chassis has a recess in which the coupling member is inserted.

7. The display apparatus of claim 6, wherein the coupling member extends in a first direction on the opposite surface and has a bar shape, and
the recess is disposed at a position corresponding to the coupling member and has a shape corresponding to the coupling member.

8. The display apparatus of claim 7, wherein the light guide panel has a rectangular shape, and
the first direction is parallel to a side of the light guide panel.

9. The display apparatus of claim 6, wherein a width of the recess in a second direction perpendicular to the first direction and parallel to the opposite surface is smaller than a width of the coupling member in the second direction, and
the coupling member is fixed by elastic force of the bottom chassis when the coupling member is inserted in the recess.

10. The display apparatus of claim 6, further comprising a fixing member coupled to the coupling member with the bottom chassis therebetween,
wherein the fixing member comprises a pin, and the coupling member comprises a pin hole in which the pin is inserted.

11. The display apparatus of claim 1, wherein the coupling member comprises a hook, and the coupling member hooks the bottom chassis.

12. The display apparatus of claim 1, wherein the light guide panel is provided in plurality, and the light guide panels are spaced apart from each other such that the light incident surfaces face each other with the light source unit therebetween,
wherein the light source unit is disposed in a space between the light guide panels.

13. The display apparatus of claim 12, wherein the light guide panels comprise protrusions protruding from the light incident surfaces and covering an upper portion of the light source unit.

14. The display apparatus of claim 13, further comprising a reflective member between the light source unit and the protrusions to reflect light emitted from the light source unit.

15. The display apparatus of claim 12, wherein the light source unit comprises a light emitting surface from which the light is emitted, and
the light emitting surface is inclined with respect to the light incident surface.

16. The display apparatus of claim 15, wherein the light guide panels comprise a first light guide panel and a second light guide panel which are adjacent to each other,
wherein the first light guide panel includes first light incident surfaces, and
the second light guide panel includes second light incident surfaces.

17. The display apparatus of claim 16, wherein the light source unit comprises a plurality of light sources that are in one-to-one correspondence to the first and second light incident surfaces.

18. The display apparatus of claim 17, wherein the first light incident surfaces are arrayed alternately with the second light incident surfaces.

19. The display apparatus of claim 1, wherein the coupling member is integrally formed with the light guide panel.

20. The display apparatus of claim 1, further comprising a reflective sheet disposed between the light guide panel and the bottom chassis to reflect the light.

21. The display apparatus of claim 1, wherein the opposite surface comprises a diffusion pattern diffusing the light.
